(19) United States
(12) Patent Application Publication
(10) Pub. No.: US 2012/0195333 A1
(43) Pub. Date: Aug. 2, 2012

(54) BROADBAND PUMP LASER STABILIZED CASCADING WAVELENGTH CONVERSION FOR GENERATING RED, GREEN AND BLUE LASER RADIATIONS

(75) Inventors: Yen-Chieh Huang, Hsinchu (TW); Yen-Yin Lin, Hsinchu (TW); Shou-Tai Lin, Hsinchu (TW)

(73) Assignee: NATIONAL TSING HUA UNIVERSITY, Hsinchu (TW)

(21) Appl. No.: 13/018,850

(22) Filed: Feb. 1, 2011

(51) Int. Cl. H01S 3/10

(52) U.S. Cl. 372/22; 372/21

(57) ABSTRACT

A laser-wavelength conversion system with a broad temperature acceptance bandwidth is provided. The laser system includes a broad-band pump laser driving one or several cascaded laser wavelength converters, wherein the pump laser spectrum is broader than the spectral acceptance bandwidth of at least one of the laser wavelength converters. The broad pump laser spectrum allows some temperature variation in the laser wavelength converters, resulting in a broad temperature acceptance for the whole laser system. The laser system provides stable multi-color laser radiation for applications such as the red-green-blue laser projection TV.

### FIELD OF THE INVENTION

The present invention relates to the use of a broadband pump laser to perform highly stable cascading laser wavelength conversion to generate red, green and blue laser radiations for color display applications. In particular, different parts of the pump laser spectral energy are used in different laser-wavelength conversion processes, resulting in a broad spectral and temperature acceptance bandwidths for the whole radiation-generation system.

### BACKGROUND OF THE INVENTION

Nonlinear laser wavelength conversion is a powerful technique to generate laser-like coherent radiations at the wavelength range where conventional laser sources are not readily available. In particular, cascading nonlinear laser-wavelength conversion allows the use of a single convenient laser source to generate laser radiations of several desirable wavelengths at the output of the radiation system. This multi-color laser-like radiation, for instance, is useful for laser projection display applications, where red, green and blue (RGB) laser radiations are needed simultaneously.

There have been numerous patents teaching cascading nonlinear laser-wavelength conversion using a single pump laser source to obtain red, green, blue (RGB) laser radiations. Examples include those taught by Bauco in U.S. Pat. No. 7,489,437 B1, Moulton in U.S. Pat. No. 5,740,190, Paschotta et al. in U.S. Pat. No. 7,016,103 B2 and Bachko et al. in U.S. Pat. No. 6,480,325 B1. However none of them teaches the use of a broadband pump laser spectrum to stabilize the RGB laser outputs.

Every nonlinear laser wavelength converter has a certain spectral acceptance bandwidth and a certain temperature acceptance bandwidth to satisfy the so-called phase matching condition for nonlinear laser wavelength or frequency conversion. Within the acceptance bandwidths, a nonlinear laser wavelength conversion process can efficiently occur. Very often varying the temperature of the wavelength converter can tune the laser wavelength at the output. To illustrate this concept in terms of laser frequencies, FIG. 1(a) shows that a single-frequency pump laser at frequency fₚ is converted to another laser at a different frequency f₁ at the phase matching temperature of the nonlinear laser crystal T₁. FIG. 1(b) is the corresponding intensities of the lasers in the spectral domain. The width of the spectral bar of the nonlinear laser wavelength converter can be considered as the intrinsic spectral acceptance bandwidth of the wavelength converter. When the temperature of the nonlinear laser crystal is changed to T₂ or T₃, the nonlinear laser wavelength converter is phase mismatched to the input laser frequency fₚ and can not generate an output.

However, when the pump laser is broad band and contains more frequency components, fₚ₁, fₚ₂, fₚ₃, it is possible for the nonlinear laser wavelength to convert the input pump frequencies at f_{p1,2,3} to output laser frequencies at f_{1,2,3} at temperature T_{1,2,3}, respectively. FIGS. 2(a)-2(b) illustrate this concept. Effectively the temperature acceptance bandwidth of the nonlinear laser wavelength converter is broadened due to the board pump spectrum.

FIG. 3 is a block diagram of a cascading laser wavelength conversion system using a narrowband pump laser system in the prior art. A narrow band pump can only produce desired laser frequency components at the output of such a system at a certain set of fixed temperatures in the nonlinear laser wavelength converters. As shown in FIG. 3, a pump laser with a fixed pump frequency fₚ drives a cascading nonlinear wavelength conversion process with the temperatures of all the wavelength converters fixed at some values (T₁, T₂ . . . Tₙ) to accomplish the generation of lasers at several desirable frequencies, f₁, f₂, f₃ . . . fₘ. Owing to the narrow bandwidth of the pump laser, the typical temperature acceptance bandwidth of such a laser system is on the order of a fraction of a degree Celsius.

In the prior art, an RGB laser system, as illustrated by FIGS. 4(a)-4(b), employs a well defined pump laser wavelength to generate RGB lasers through a cascading nonlinear wavelength conversion process. In FIG. 4(a), a near infrared laser containing frequency component fₚ pumps an optical parametric oscillator (OPO) to generate a signal frequency fₛ and an idler frequency fᵢ=fₚ−fₛ. The generated new laser frequencies are then used to generate more laser frequencies f_{R}=fₛ+fₚ, f_{G}=2×fₚ, f_{B}=fₛ+f_{R} at the RGB colors in three more nonlinear laser wavelength converters, labeled as SFG-R, SHG-G, and SFG-B, respectively. To satisfy the phase matching condition for nonlinear laser wavelength conversion, the four nonlinear laser wavelength converters, OPO, SFG-R, SFG-B, and SHG-G have to be set at fixed temperatures T₁, T₂, T₃ and T₄, respectively. FIG. 4(b) shows a column graph of the spectral intensity versus the frequency for those frequencies shown in FIG. 4(a). For example, the pump laser wavelength can be at 1064 nm, the signal laser wavelength can be at 1562 nm, the red laser wavelength generated from the sum frequency generator (SFG-R) is then at 633 nm, the green laser wavelength from the second harmonic generator (SHG-R) is therefore 532 nm, and the blue laser wavelength from second SFG (SFG-B) is 450 nm.

However, every nonlinear wavelength conversion process has an acceptance bandwidth set by the dispersion and length of a given nonlinear optical material in which nonlinear frequency mixing is performed. Cascading nonlinear laser wavelength conversion employs a single pump laser source and multiple nonlinear optical materials, resulting in a much stringent acceptance bandwidth for the whole system to satisfy all the dispersion properties of different nonlinear optical materials. In particular, the energy coupling among different radiation components in a single-laser pumped cascading nonlinear laser wavelength conversion system often shows instability in laser output powers subject to variations of temperatures in the nonlinear optical materials. The drift of the pump laser wavelength due to, say, thermal effects could also cause instability to the output of the whole laser system. It is therefore an objective of the present invention to employ a broadband pump laser to naturally stabilize the laser output powers of different wavelengths in a laser system adopting cascading nonlinear laser wavelength conversion. In such a system, different parts of the pump laser spectral energy contribute to the acceptance bandwidths of different laser wavelength conversion processes and thereby decouple the instability from the cascading process.

To alleviate the drawbacks in the prior arts, the applicant carried out a major research-and-development effort to conceive and implement a broadband pump laser stabilized cascading wavelength conversion for generating red, green and blue laser radiations.

### SUMMARY OF THE INVENTION

An objective of the present invention is to employ a broadband pump laser to naturally stabilize the laser output powers of different wavelength components in a laser system adopting cascading nonlinear laser wavelength conversion. The laser system comprises at least one nonlinear laser wavelength converter. The pump laser spectrum is broader than the acceptance bandwidths of individual nonlinear laser wavelength converters. In such a system, different parts of the pump laser spectrum contribute to the acceptance bandwidths of different laser wavelength converters, so that the output instability resulting from energy coupling among the laser wavelength converters is minimized.

It is therefore another objective of the present invention to employ a broadband laser to pump a cascaded nonlinear laser wavelength conversion system to generate highly stable laser outputs at the red, green and blue colors for laser display applications.

According to a first preferred embodiment of the present invention, a laser system comprises a broad-band pump laser driving a nonlinear laser wavelength converter.

According to a second preferred embodiment, a laser system comprises a broad-band pump laser driving cascaded nonlinear laser wavelength converters.

The present invention can be best understood through the following descriptions with reference to the accompanying drawings, in which:

### BRIEF DESCRIPTION OF THE DRAWINGS

FIGS. 1(a)-1(b) depict the concept of narrow-band laser pumped nonlinear laser wavelength conversion in the prior art;

FIGS. 2(a)-2(b) depict the concept of broadband laser pumped nonlinear laser wavelength conversion according to the first preferred embodiment of the present invention;

FIG. 3 depicts a block diagram of a cascading laser wavelength conversion system using a narrowband pump laser in the prior art;

FIG. 4(a) depicts a cascading laser wavelength conversion process of an RGB laser system pumped by a narrowband laser to generate RGB lasers in the prior art;

FIG. 4(b) depicts a column graph of the spectral intensity versus frequency for those involved laser frequency components shown in FIG. 4(a);

FIG. 5 depicts a block diagram of using a broad-band pump laser to generate highly stable multi-color laser radiations from cascading nonlinear laser-wavelength conversion according to the second preferred embodiment of the present invention;

FIG. 6(a) depicts a cascading laser wavelength conversion process of using a broadband pump laser to generate highly stable RGB colors of laser radiation according to the third preferred embodiment of the present invention;

FIG. 6(b) depicts a column graph of the spectral intensity versus frequency for those involved frequency components shown in FIG. 6(a);

FIG. 7 depicts a schematic diagram of a realized RGB optical parametric oscillator (OPO) according to the third preferred embodiment of the present invention;

FIG. 8 depicts cavity-mode radius of the resonated infrared signal wave versus position in the OPO cavity;

FIGS. 9(a)-9(b) depict the measured red, blue, green laser powers versus pump power from the realized RGB OPO;

FIG. 10 shows the depletion of the pump spectrum by the OPO, in which the dashed line denotes the original pump spectrum, and the undepleted pump spectral energy under the continuous curve is further converted to the red, blue, and green lasers in the subsequently cascaded wavelength converters, SFG-R, SFG-B, and SHG-G, respectively; and

FIGS. 11(a)-11(c) show the measured temperature tuning curves for the generated red, blue, green lasers, respectively.

### DETAILED DESCRIPTION OF THE PREFERRED EMBODIMENT

Although the following description contains many specifications for the purposes of illustration, anyone of ordinary skill in the art will appreciate that many variations and alterations to the following details are within the scope of the invention. Accordingly, the following preferred embodiment of the invention is set forth without any loss of generality to and without imposing limitations upon, the claimed invention.

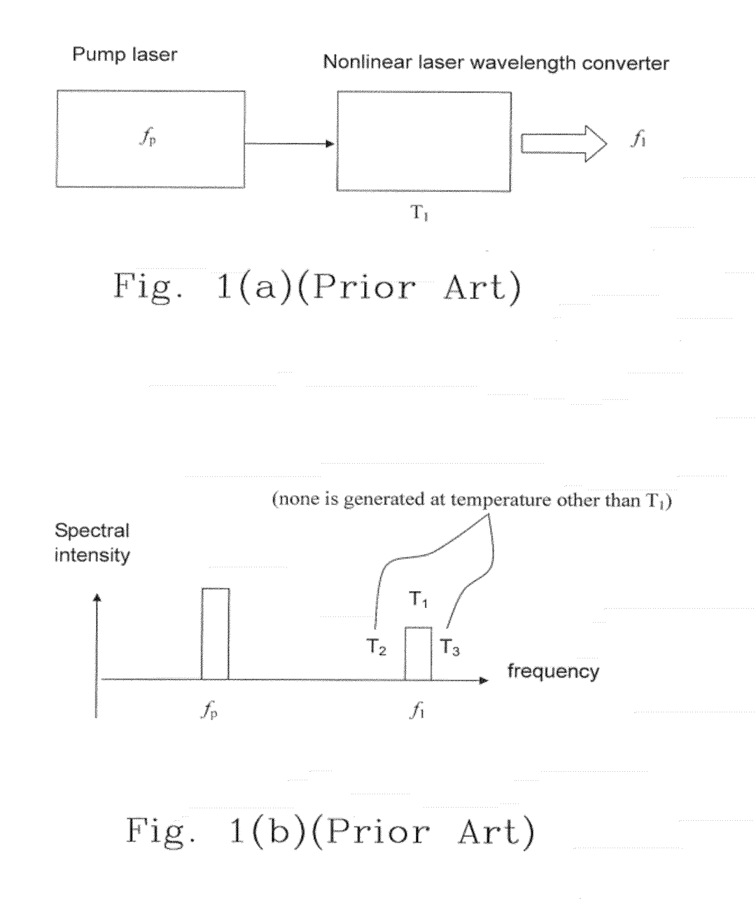

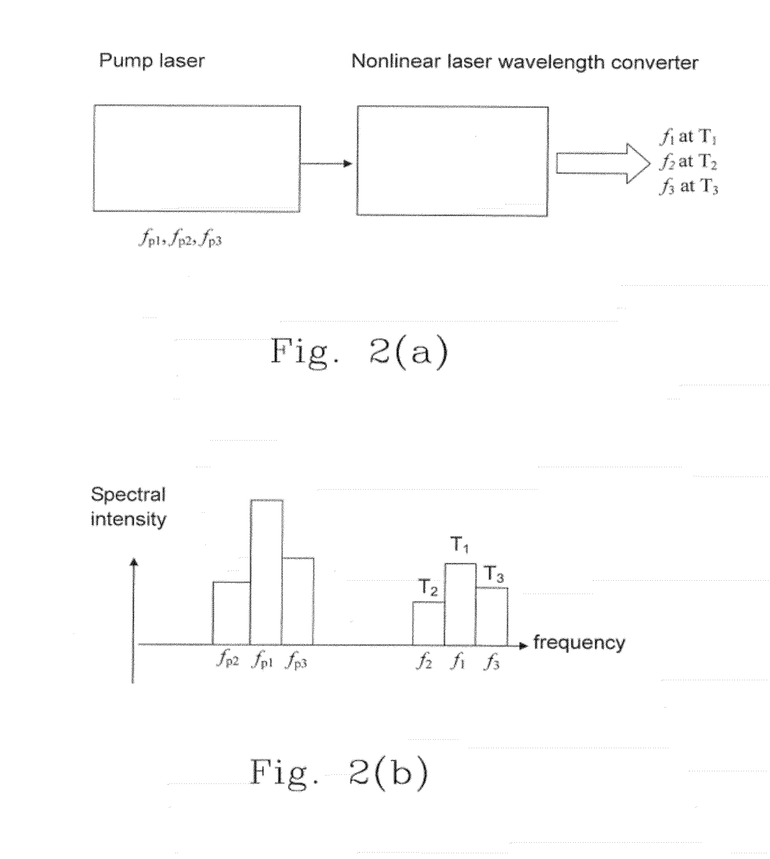

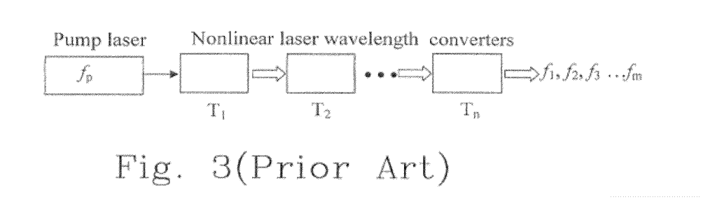

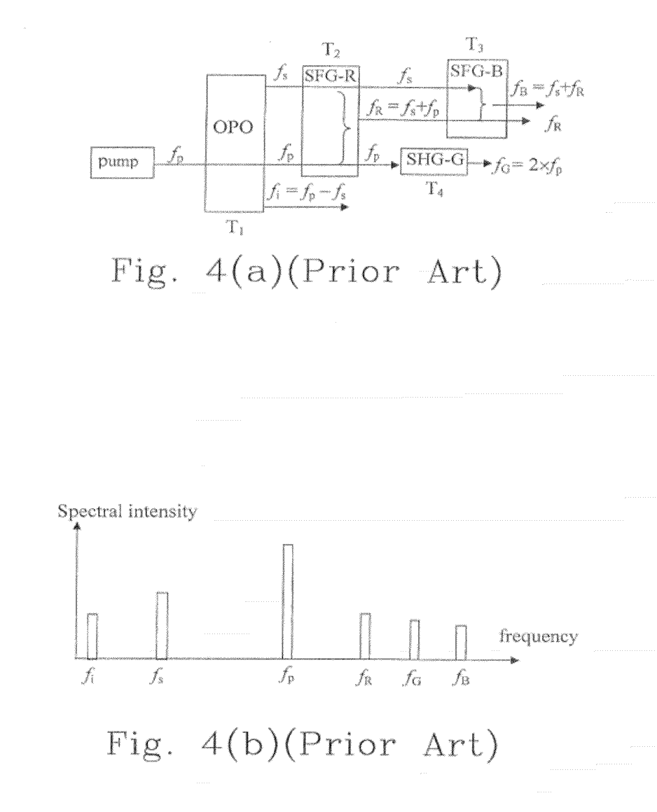

It is an objective of the present invention to employ a broadband pump laser to greatly stabilize the laser output powers of different wavelengths in a laser system adopting cascading nonlinear laser wavelength conversion. FIGS. 2(a)-2(b) illustrate the concept of broadband pumped nonlinear laser wavelength conversion according to the first preferred embodiment of the present invention. FIG. 2(a) shows that a broad-band laser containing multi-frequency components fₚ₁, fₚ₂, and fₚ₃ is converted to another laser radiating at f₁, f₂, or f₃ at the phase matching temperatures of the nonlinear laser wavelength converters T₁, T₂, or T₃, respectively. FIG. 2(b) is the corresponding intensities of the lasers in the spectral domain. Unlike the narrow-band laser pumped system in FIG. 1 operating at a single temperature T₁, the broad-band laser pumped system in FIG. 2 can have a broader temperature acceptance bandwidth covering T₁, T₂, and T₃.

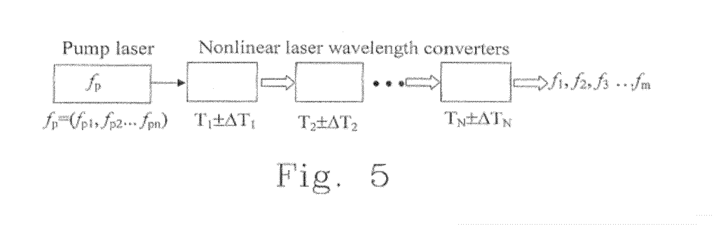

FIG. 5 shows a schematic diagram of an application example of using a broadband pump laser to generate highly stable RGB colors of multi-color laser radiations from cascading nonlinear laser-wavelength conversion according to the second preferred embodiment of the present invention. In FIG. 5, a broad band pump laser comprises several pump frequency components fₚ=(fₚ₁, fₚ₂ . . . fₚₙ) in a spectral band broader than the individual acceptance bandwidths of the nonlinear laser wavelength converters, allowing some temperature variations in the nonlinear laser wavelength converters (e.g., T₁±ΔT₁, T₂±ΔT₂ . . . T_{N}±ΔT_{N}) while generating desired laser frequencies (f₁, f₂, f₃ . . . fₘ) at the output. The laser pump spectrum fₚ=(fₚ₁, fₚ₂ . . . fₚₙ), while containing multiple frequency components fₚ₁, fₚ₂ . . . fₚₙ, can be a continuous distribution. In such a multi-color laser system, different parts of the pump laser spectrum can contribute to the acceptance bandwidths of different laser wavelength conversion processes and thereby decouple the instability from the cascading laser-wavelength process. In the event of a temperature variation ΔTᵢ, i=1, 2, . . . N, in the i-th laser wavelength converter, a suitable part of the broad pump laser spectrum can still be supplied to the i-th laser wavelength converter to generate a desired laser output color.

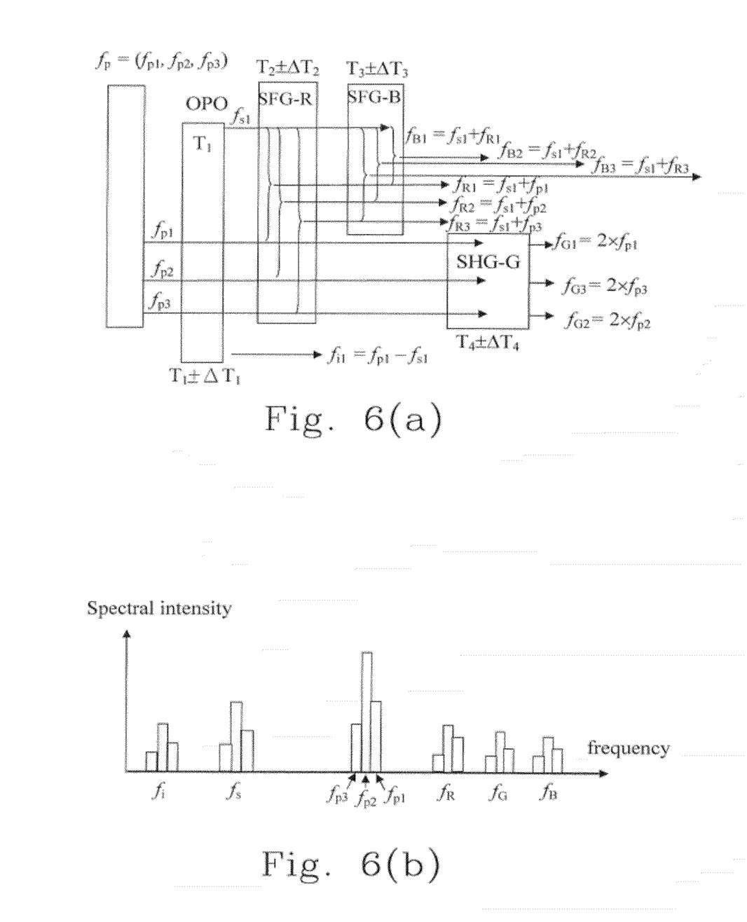

FIG. 6(a) shows a cascading laser wavelength conversion process of an application example of using a broadband pump laser to generate highly stable RGB colors of laser radiation according to the third preferred embodiment of the present invention. In FIG. 6(a), a near infrared laser containing, for instance, three primary spectral components fₚ=(fₚ₁, fₚ₂, fₚ₃) pumps a first laser wavelength converter in an optical parametric oscillator (OPO) to generate a signal frequency fₛ=(fₛ₁, fₛ₂, fₛ₃) and idler frequency fᵢ=(fᵢ₁, fᵢ₂, fᵢ₃) at temperatures T₁, T₁−ΔT₁, and T₁+ΔT₁ with the frequency relationships f_{p1,2,3}=f_{s1,2,3}+f_{i1,2,3}, respectively. Within a temperature variation range T₁−ΔT₁≦T≦T₁+ΔT₁, all the generated signal spectral components can be used for subsequent laser wavelength conversions. In some OPO design such as the singly resonant OPO (SRO), the signal radiation is narrow-band, resulting in fₛ₁=fₛ₂=fₛ₃. However, this narrow band signal component can still be summed with any of the fₚ in the subsequent nonlinear laser wavelength converters to generate a temperature-insensitive laser output. Illustrated in the plot is that at an OPO temperature the signal photon fₛ₁ is combined with the pump photon in a 2^{nd} laser wavelength converter SFG-R to generate the red color photon at frequency f_{R}. The temperature of the SFG-R is allowed to vary to utilize different parts of the pump spectral components to perform the sum frequency generation for the pump and signal photons, resulting in several possible output frequencies for the red-laser output f_{R12,3}. The red-laser photon is further combined with the signal photon in a 3^{rd} laser wavelength converter SFG-B, appended to the previous one, to generate a blue-color photon at frequency f_{B}. Again, owing to the broad pump spectrum and the resulting broad red-laser spectrum, the temperature of the SFG-B is allowed to vary to utilize different parts of the red-laser and the signal-laser spectral energy to generate the blue-laser photon. Showed in FIG. 6(a) are three possible blue-laser output spectral components f_{B12,3} generated from three possible temperatures for SFG-B. The effective temperature acceptance bandwidth of SFG-B is therefore broadened due to the broad-band pump laser. The residue, undepleted pump laser can be further frequency doubled to generate the green laser photons in a 4^{th} laser wavelength converter SHG-G. Again, owing to the broad pump spectrum, the temperature of the SHG-G can be varied to utilize different parts of the pump spectral energy to generate the green-color laser. As a result, the RGB laser system is insensitive to temperature variation in the wavelength converters or immune to the instability of the pump laser spectrum.

FIG. 6(b) shows a column graph of the spectral intensity versus frequency for those involved frequencies shown in FIG. 6(a). Since the laser pump spectrum is designed to be broader than any of those laser wavelength converters, each laser output spectrum may contain multiple frequency components derived from some part of the broadband pump laser spectrum. One of the spectral components at the output of a laser wavelength converter (for instance, f_{R1} summed from fₛ₁ and fₚ₁) could be stronger than the others when a temperature is given to a laser wavelength converter. Upon some change of the temperature in the laser wavelength converter, a slightly different spectral component (for instance, f_{R2}) could be generated from the process of summing fₛ₁ and fₚ₂ governed by the temperature-tuned phase matching condition of the nonlinear laser wavelength conversion. Thanks to the broad pump spectrum, the fₚ₂ pump component is available from the pump laser for generating the red-color laser radiation at f_{R2} despite the temperature variation in the laser wavelength converter SFG-R. Consequently, the temperature acceptance bandwidth of the SFG-R wavelength converter is effectively increased. This broadened temperature acceptance bandwidth occurs to each of the laser wavelength converters in FIG. 6(a) due to the broadband pump laser. As a result, the overall RGB laser system is relatively insensitive to temperature variation.

### Embodiments

1. A laser system comprising a broad-band pump laser driving a nonlinear laser wavelength converter.

2. A laser system according to Embodiment 1 having a pump laser bandwidth being broader than that of the nonlinear laser wavelength converter.

3. A laser system according to Embodiment 1 or 2, wherein the nonlinear laser wavelength converter is selected from a group consisting of a second harmonic generator, a sum frequency generator, a difference frequency generator, an optical parametric oscillator, and a Raman oscillator.

4. A laser system according to any of the aforementioned Embodiments having output laser color comprising at least one of a red color, a green color and a blue color.

5. A laser system according to any of the aforementioned Embodiments having an output, wherein a broad spectrum of the pump laser broadens the temperature acceptance bandwidth of the nonlinear laser wavelength converter while enabling generation of desired laser wavelengths at the output.

6. A laser system comprising a broad-band pump laser driving cascaded nonlinear laser wavelength converters.

7. A laser system according to Embodiment 6 having a pump laser bandwidth being broader than that of at least one of the cascaded nonlinear laser wavelength converters.

8. A laser system according to Embodiment 6 or 7, wherein the nonlinear laser wavelength converters are selected from a group consisting of a second harmonic generator, a sum frequency generator, a difference frequency generator, an optical parametric oscillator, a Raman oscillator and a combination thereof.

9. A laser system according to any of the aforementioned Embodiments having output laser colors comprising at least one of a red color, a green color and a blue color.

10. A laser system according to any of the aforementioned Embodiments having an output, wherein a broad spectrum of the pump laser broadens the temperature acceptance bandwidths of the cascaded nonlinear laser wavelength converters while enabling generation of desired laser wavelengths at the output.

### Experimental Realization of the Invention

### 1. Experiment Setup

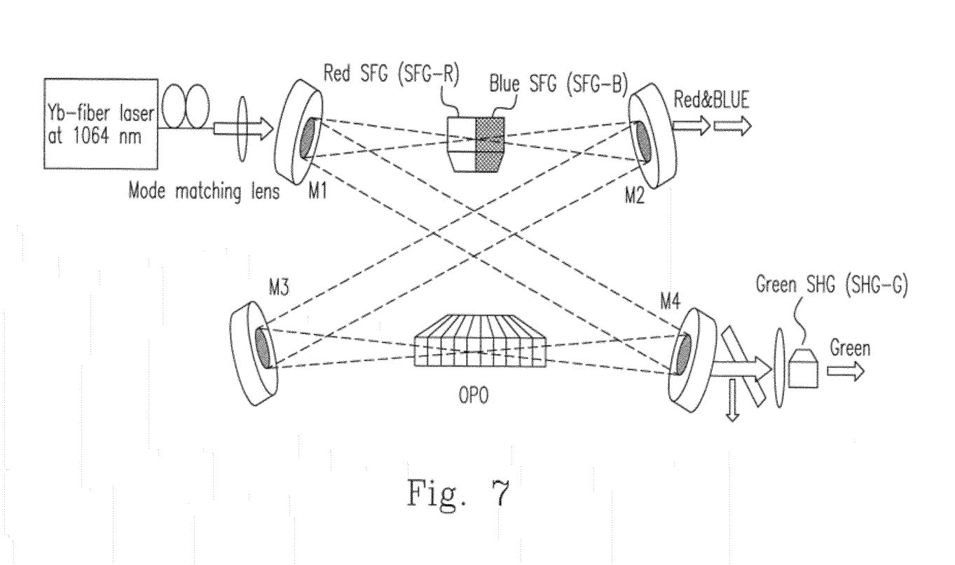

The schematic diagram of a realized RGB OPO according to the second preferred embodiment of the present invention is shown in FIG. 7. The OPO was pumped by a broadband Yb-fiber laser at 1064 nm and designed to resonate the signal component at 1562 nm. The corresponding idler component is at 3337 nm. Since the OPO only resonates the signal component, this is an SRO design. This SRO comprises four curved mirrors with a 100 mm radius of curvature arranged in a bow-tie ring-cavity configuration. The four mirrors are highly reflecting at the signal wavelength, 1562 nm. In this work, 5-mol. %-doped MgO:PPLN crystals were used as the material for all the nonlinear wavelength converters.

The OPO PPLN crystal was 50 mm in its length and 30.4 m in its period, phase matched to the 1^{st}-order parametric mixing of 1/1064 nm→1/1562 nm+1/3337 nm at 90° C. The SFG-R crystal was 10 mm in its length and 11.8 m in its period, phase matched to the 1^{st}-order sum frequency process of 1/1064 nm+1/1562 nm→1/633 nm at 92° C. The SFG-R crystal was 10 mm in its length and 4.7 μm in its period, phase matched to the sum frequency process of 1/633 nm+1/1562 nm→1/450 nm at 75° C. The two end faces of all the PPLN crystals were optically polished and coated with 3, 1.5, 1, 0.25, and 14% reflectance at the blue, red, pump, signal and idler wavelengths, respectively. To independently tune the red and blue wavelengths, the MgO:PPLN crystals were installed in different ovens with ±0.1° C. temperature resolution. One could certainly make a monolithic crystal for the red and blue SFGs in a single oven, when there is a need for mass production The residual pump power was converted into green laser radiation in a single-pass SHG. The SHG PPLN crystal was 5 mm in its length and 6.5 μm in its period, phase matched to the 1^{st}-order second harmonic process of 1/1064 nm+1/1064 nm→1/532 nm at 82° C. The chosen RGB wavelengths of the proposed system covers 35% more area on the CIE 1931 standard chromaticity diagram than that covered by a typical National Television Standards Committee (NTSC) Primaries, R(0.67,0.33) G(0.21, 0.71) B(0.14, 0.08).

To obtain high intracavity power for better nonlinear conversion efficiency at the red and blue wavelengths, the four cavity mirrors all had high reflectance (>99.8%) at the signal wavelength. The input mirror, M₁, had reflectance of 1, 99.8, and ˜4% at the pump, signal and idler wavelengths, respectively. Mirror M₄, made of fused silica, had reflectance of 1.0, 99.9, and ˜2% at the pump, signal and idler wavelengths, respectively. The mid-IR idler output power can be monitored through the fused silica mirror. To deflect the pump laser into the OPO crystal and couple out the red power, the remaining two mirrors, M₂ and M₃, were both optically coated with reflectance of 99.8, 99.8, 4.0, and ˜5% at the pump, signal, idler and red wavelengths, respectively. The M₁ and M₂ mirrors were separated by 100 mm, and the M₃ and M₄ mirrors were separated by 140 mm. The total cavity length of the ring SRO is 500 mm.

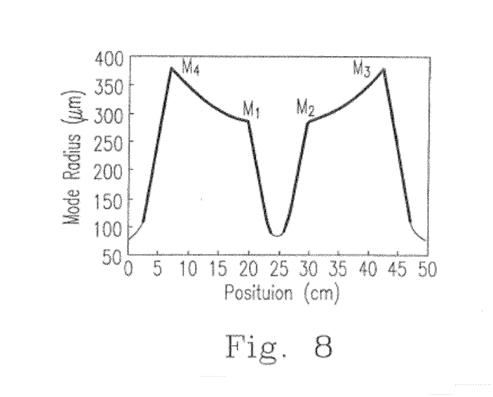

FIG. 8 shows cavity-mode radius of the resonated IR signal wave versus position in the SRO cavity. Due to symmetry, the four curved cavity mirrors form focal points at the center of the OPO crystal and near the center of the two SFG crystals. The coarse curves represent the mode radius in free space; the fine curves represent the mode radius in the SFG and the OPO crystals. The waist radius of the two focal points was about 80 μm

The pump laser is a linearly polarized Yb-fiber laser at 1064 nm, producing a maximum CW power of 25 W in a ˜1-nm (265 GHz) linewidth. The pump beam was polarized along the crystallographic z direction of the MgO:PPLN crystal and mode-matched to the SRO cavity by using a 150-mm focal-length lens. The pump beam enters the SRO cavity at the M₁ mirror, traverses the SFG crystals, and reflects from the M₂ and M₃ mirrors to pump the OPO crystal. The residual pump beam exits at the M₄ mirror. A dichroic mirror is employed to separate the idler and pump waves and an additional 75 mm focal-length lens was used to refocus the pump beam to the center of the SHG crystal for green laser generation.

### 2. Result and Discussion

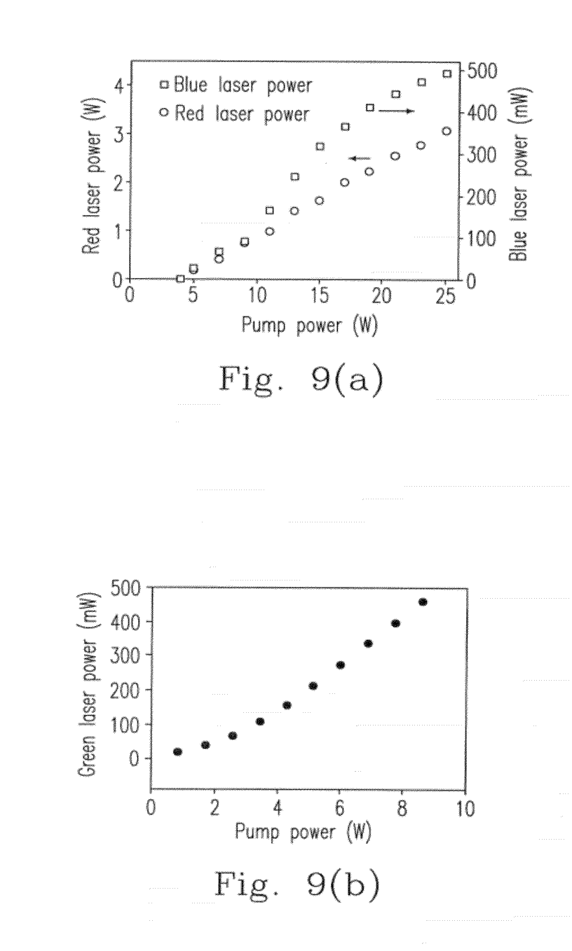

FIG. 9(a) shows the measured red and blue laser powers versus pump power. As soon as the pump power overcomes the cavity threshold (4 W), the red and blue laser powers increase monotonically with the pump power. At 25-W pump power, 3-W red laser power at 633 nm and 0.5-W blue laser power at 450 nm were emitted through mirror M₂. The residue, undepleted pump power exiting M₄ is sent into SHG-R for green laser generation. FIG. 9(b) shows the green laser power as a function of the residue pump laser power. A maximum amount of 0.46 W green laser power was produced.

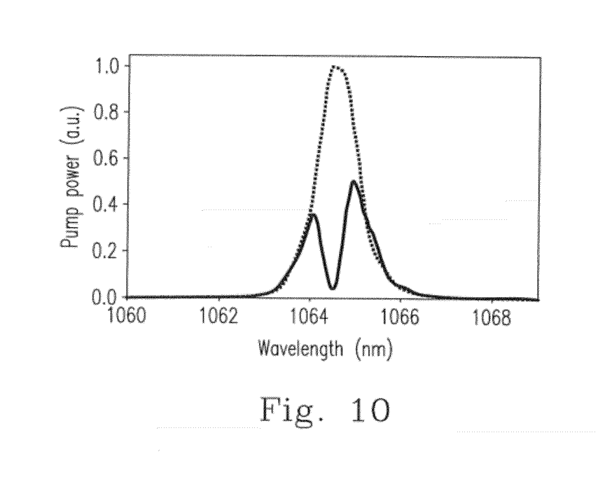

FIG. 10 shows the depleted pump spectrum when the two SFG crystals were not present in the OPO cavity. For comparison, the input spectrum of the pump laser is also shown in the figure with a dashed line. Owing to a pump spectrum broader than the OPO's spectral acceptance bandwidth, only 160 GHz out of the total 265 GHz pump spectrum is used for the OPO parametric conversion process. Different portions of the undepleted pump spectral energy continue to participate in subsequent laser wavelength conversions. In the event of some temperature variation in a laser wavelength converter, the wavelength conversion process in this very converter is relatively unaffected, because a different portion of the pump spectral energy can still be access by the crystal to generate the desired laser color. Consequently, the effective temperature acceptance for each nonlinear wavelength converter is broadened due to the broad pump spectrum.

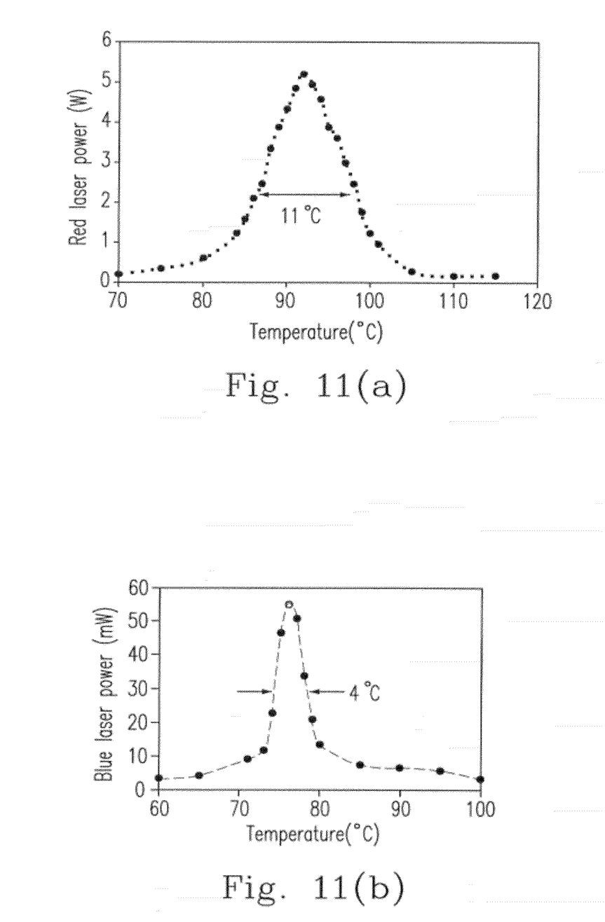

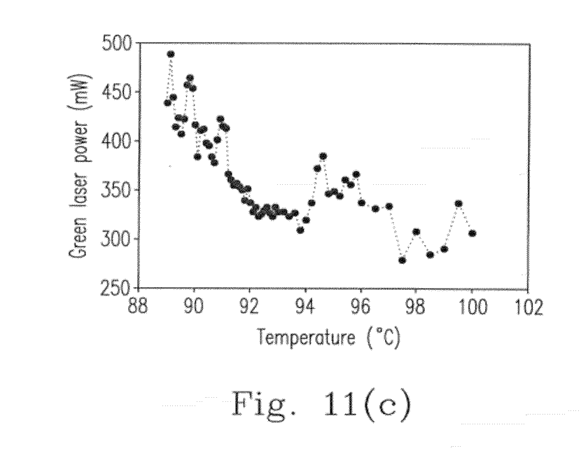

FIGS. 11(a)-11(b) show measured temperature acceptance bandwidths of 11 and 4° C. for the red and blue laser wavelength converters (SFG-R and SFG-B), respectively. FIG. 11(c) shows the measured green laser power versus temperature in the SHG crystal, indicating a very broad temperature range of operation. The nominal temperature acceptance bandwidth of cascaded wavelength converters in a similar RGB OPO system pumped by a narrow-band laser is about a fraction of a degree Celsius. On the contrary, the experimental realization of the present invention shows much broader temperature acceptance bandwidths in FIG. 11.

### 3. Conclusion

A CW RGB OPO with an ultra-broad temperature acceptance bandwidth has been successfully realized by using a SRO installed with two intracavity SFGs and one extracavity SHG. The RGB OPO laser system is pumped by a multi-longitudinal-mode, broad-band (265 GHz) Yb-fiber laser at 1064 nm. All the wavelength converters were made of MgO:PPLN crystals. The red, green, and blue lasers are produced by summing the frequencies of the pump and signal lasers, doubling the frequency of the residual pump laser, and summing the frequencies of the red and signal lasers, respectively. At 25-W pump power, 3.9, 0.46 and 0.49 W powers at 633, 532 and 450 nm, respectively, were generated from the CW RGB SRO. The two separated SFGs offer independent wavelength tuning to the red and blue colors of the laser. The extracavity SHG offers another independent adjustment to the green-laser power without affecting the output power of the red and blue lasers. A very unique feature of the RGB OPO is that different spectral components in the broad pump spectrum can contribute to different wavelength conversion processes in the cascaded nonlinear laser wavelength converters, resulting in a very broad temperature bandwidth for the whole system.

According to the aforementioned descriptions, the present invention utilizes a broadband pump laser to naturally stabilize the laser output powers of different wavelength components in a laser system adopting cascading nonlinear laser wavelength conversion. The pump laser spectrum is broader than the spectral acceptance bandwidth of individual nonlinear laser wavelength converters. In such a system, different parts of the pump laser spectral energy are taken by different laser wavelength converters, so that the output instability resulted from energy coupling among different laser wavelength converters is minimized. It is therefore another objective of the present invention to employ a broadband laser to pump a cascading nonlinear laser wavelength conversion system to generate highly stable laser outputs at the red, green and blue colors for laser display applications so as to possess the non-obviousness and the novelty.

While the present invention has been described in terms of what are presently considered to be the most practical and preferred embodiments, it is to be understood that the present invention needs not be restricted to the disclosed embodiments. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A laser system comprising a broad-band pump laser driving a nonlinear laser wavelength converter.

2. A laser system according to claim 1 having a pump laser bandwidth being broader than the spectral acceptance bandwidth of the nonlinear laser wavelength converter.

3. A laser system according to claim 1, wherein the nonlinear laser wavelength converter is selected from a group consisting of a second harmonic generator, a sum frequency generator, a difference frequency generator, an optical parametric oscillator, and a Raman oscillator.

4. A laser system of claim 1 having output laser color comprising at least one of a red color, a green color, and a blue color.

5. A laser system of claim 1 having an output, wherein a broad pump laser spectrum broadens the temperature acceptance bandwidth of the nonlinear laser wavelength converter while enabling generation of desired laser wavelengths at the output.

6. A laser system comprising a broad-band pump laser driving cascaded nonlinear laser wavelength converters.

7. A laser system according to claim 6 having a pump laser bandwidth being broader than that of at least one of the cascaded nonlinear laser wavelength converters.

8. A laser system according to claim 6, wherein the nonlinear laser wavelength converters are selected from a group consisting of a second harmonic generator, a sum frequency generator, a difference frequency generator, an optical parametric oscillator, a Raman oscillator and a combination thereof.

9. A laser system of claim 6 having output laser colors comprising at least one of a red color, a green color and a blue color.

10. A laser system of claim 6 having an output, wherein a broad pump laser spectrum broadens the temperature acceptance bandwidths of the cascaded nonlinear laser wavelength converters while enabling generation of desired laser wavelengths at the output.
